(19) United States
(12) Patent Application Publication
(10) Pub. No.: US 2008/0121297 A1
(43) Pub. Date: May 29, 2008

(54) Stopcock Closure Plug

(76) Inventor: Mark Indigne, Willebroek (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/794,479

(22) PCT Filed: Jan. 3, 2005
(86) PCT No.: PCT/EP05/50005

§ 371 Date: Oct. 26, 2007

(51) Int. Cl. F16K 41/10; F16K 5/04

(52) U.S. Cl. 137/625.47; 251/309

(57) ABSTRACT

The invention relates to a stopcock for fluids, comprising a housing (2) with an inlet (3) and an outlet (4) access and a closure plug (1) in the housing, with a spindle nut (9) and a closure membrane (6) adhering thereto, controlling the passage between the inlet (3) and outlet (4), wherein said closure membrane (6) is made of thermoplastic elastomer (TPE). The invention also relates to closure plugs for controlling the passage between the inlet and outlet of a stopcock, involving a closure membrane made of thermo-=plastic elastomer (TPE).

The invention relates to stopcock closure plugs, more particularly to stopcock closure plugs with a closure membrane of synthetic material.

In the field of handling food and beverages, in particular drinking water, very stringent criteria are being applied to the materials that come into contact therewith.

Whereas appropriate materials for the pipes and conducts for handling such type of products are now commonly available, there remained serious difficulties in finding appropriate stopcocks meeting the stringent criteria referred to.

Recently a new stopcock technology was proposed in EP 1 462 695, comprising a housing with inlet and outlet accesses and a housing cover entirely made of synthetic/plastic material.

This new stopcock technology however still involves problems in respect of the material for the closure membrane. No proper material could be found that satisfies at the same time a proper adherence (grip) of the closure: membrane to the spindle nut of the closure plug and extremely low levels of extractable elements as desirable for food and drinking water applications. A compromise had to be settled on low toxicity synthetic rubbers which involve an in situ vulcanization/curing on the spindle nut for ensuring proper grip.

It is an objective of this invention to overcome the drawbacks of state of the art stopcocks by providing a stopcock in which all materials in contact with the liquid (drinking water) can consist of materials that satisfy very stringent health and safety criteria, and in particular all approvals for use in direct contact with food, medical approvals and approvals for water in accordance with EC rules, US FDA approval, medical USP class VI compliance and water-WRC criteria.

The invention therefor provides a stopcock, in particular a stopcock comprising a housing with an inlet and an outlet access and a closure plug in the housing, and with a spindle nut (being the driving spindle for the closure plug) and a closure membrane adhering thereto, controlling the passage between the inlet and outlet, wherein the stopcock closure plug membrane is made of thermoplastic elastomer (TPE).

The expression “thermoplastic elastomer” or TPE as used in the present specification does not refer to a specific class of chemical compounds but rather to a class of materials having a specific property profile, namely any polymeric material which is processable as a typical thermoplastic material (in terms of injection molding, extrusion or blow molding processability, and in terms of recyclability) but has mechanical properties comparable to rubbers (in terms of flexibility—i.e. low stiffness—and elasticity—i.e. compression set and tension set—).

According to a preferred feature of the invention the TPE used for the stopcock closure plug membrane is suitably a polyester-polyether type TPE or a polyester-polyester type TPE.

Particularly appropriate TPE types are for instance the products commercialized by the company DSM under the references “ARNITEL E”, “ARNITEL P” and “ARNITEL U”.

The stopcock closure plug membranes according to the invention are particularly suitable for use in stopcocks “essentially made of synthetic/plastic material”, such as stopcocks comprising a housing cover and a housing with its inlet and outlet accesses entirely made of synthetic/plastic material, as described in EP 1 462 695, the disclosure of which is hereby incorporated in this specification.

Particularly suitable stopcocks in this context, comprise, for instance, a housing and housing cover made of a, optionally fiber reinforced, material selected from polypropylene, polyphenylene ether and polyamide, optionally reinforced with fibers (glass fibers or other engineering fibers), and/or a housing with its inlet and outlet accesses consisting of a molded plastic piece comprising a longitudinal duct with longitudinal reinforcing ribs, and a plug cavity provided with its axis perpendicular to said longitudinal duct, with reinforcing ribs of said plug cavity extending parallel to its axis and with at least three peripheral reinforcement zones for fixing the housing cover to the housing, and a housing cover consisting of a molded plastic piece comprising a cover surface with radial reinforcement ribs and/or one or more peripheral rib(s), perpendicular to the plane of said cover surface, with at least three peripheral reinforcement zones for fixing the housing cover to the housing, and a hollow protrusion, along the axis of said plug cavity, for holding said driving spindle for the closure plug, provided with radial reinforcement ribs.

The invention also specifically relates to closure plugs for controlling the passage between the inlet and outlet of a stopcock for fluids, comprising a spindle nut and a closure membrane adhering thereto, wherein said closure membrane is made of thermoplastic elastomer (TPE), in particular a polyester-polyether type TPE or a polyester-polyester type TPE.

According to a preferred feature of the invention the spindle nut of such closure plug comprises means for ensuring proper adherence/grip of the TPE closure membrane to the closure plug spindle nut, such as bores and/or grooves into which penetrates the TPE material of the closure membrane, or grooves and/or protrusions cooperating with adapted/corresponding ribs and/or grooves on the inside of the closure membrane, to allow a forced “one-way” introduction/setting of the spindle nut in the closure membrane.

Whereas with conventional rubbers no real problems are encountered in respect to the adherence or grip of the membrane to the spindle nut, due to the in situ curing (vulcanization/cross-linking/polymerization) of the rubber compound on the spindle nut, for the stopcocks and the closure plugs according to the invention, a limited adherence occurs with the thermoplastic elastomer.

According to a further preferred feature of the invention the spindle nut of the closure plug can therefore most suitably comprise means for ensuring proper adherence/grip of the TPE closure membrane to the closure plug spindle nut.

In a first preferred embodiment of the invention, such means may be linked to the fact that the spindle nut comprises bores and/or grooves into which penetrates the TPE material of the closure membrane.

This penetration of the TPE material into the bores and/or grooves of the spindle nut may for instance result from injecting molten TPE on the spindle nut in a mould for shaping the plug membrane.

In another preferred embodiment of the invention, the means for ensuring proper adherence/grip of the TPE closure membrane to the closure plug spindle nut may reside in the fact that the spindle nut comprises grooves and/or protrusions cooperating with adapted/corresponding ribs and/or grooves on the inside of the closure membrane, to allow a forced “one-way” introduction/setting of the spindle nut in the closure membrane.

Further features and details of the invention will become apparent from the following description of two specific embodiments of the invention, given by way of mere illustrative examples, having reference to the attached drawings.

In those drawings:

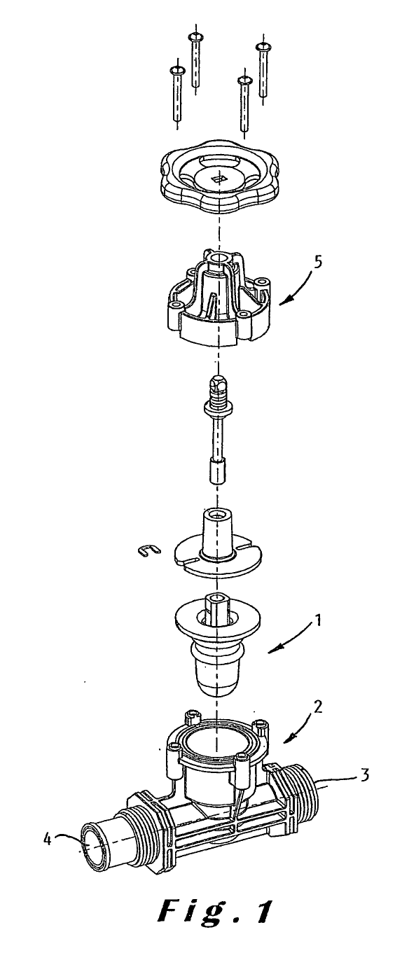

FIG. 1 represents a view, in perspective, of a stopcock closure plug in accordance with the invention;

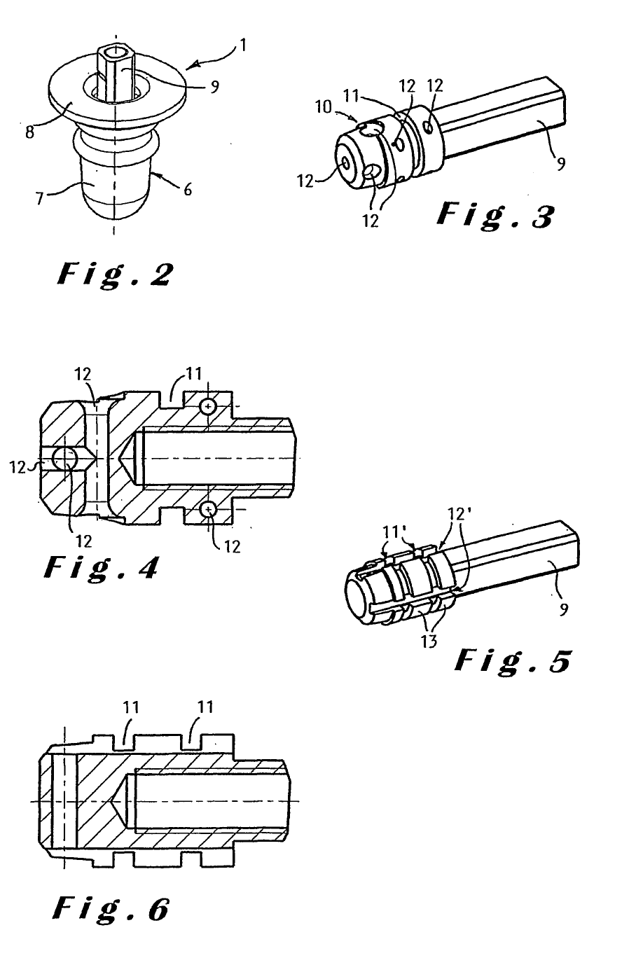

FIG. 2 represents the stopcock closure plug of FIG. 1, in an exploded view of a plastic stopcock according to EP 1 462 695;

FIG. 3 represents a view, in perspective, of a first embodiment of a spindle nut for a stopcock closure plug with a TPE closure membrane according to the invention;

FIG. 4 represents a section view of the spindle nut according of FIG. 3;

FIG. 5 represents a view, in perspective, of another embodiment of a spindle nut for a stopcock closure plug with a TPE closure membrane according to the invention;

FIG. 6 represents a section view of the spindle nut according of FIG. 5;

The stopcock shown in FIG. 1 comprises
a housing (2) with its outlet access (3) and its inlet access (4) and
a housing cover (5)
(both consisting of moulded (and/or tooled) plastic pieces),
and a stopcock closure plug (1) as further detailed in FIG. 2 and here below.

The stopcock closure plug (1) comprises an “elastic” closure membrane (6)—with a plug part (7) adapted to control the fluid passage of the stopcock and a flange part (8) adapted to be clamped (together with an intermediate bush) between the housing (2) and housing cover (3)—adequately fitted to a spindle nut (9).

In accordance with the invention, the “elastic” closure membrane is made of a thermoplastic elastomer (TPE), as specifically defined in this specification. According to the embodiment of the invention shown in FIGS. 3 and 4, the means for ensuring adequate fitting (adherence/grip) of the TPE material to the spindle nut (9) involves a spindle nut head part (10) with a circumferential groove (11) and with several transverse bores or channels (12).

When injecting the molten thermoplastic elastomer on the spindle nut head part (10)—in an appropriate mould—the molten TPE penetrates into the groove (11) and bores (12), thus providing proper adherence/grip of the plug membrane to the spindle nut head.

According to the embodiment of the invention shown in FIGS. 5 and 6, the means for ensuring adequate fitting (adherence/grip) of the TPE material to the spindle nut (9′) involves a spindle nut head part (10′) with circumferential grooves (11′) and longitudinal grooves (12′), and corresponding ribs/protrusions (13).

When injecting the molten thermoplastic elastomer on the spindle nut head part (10′)—in an appropriate mould—the molten TPE penetrates into the grooves (11′) and (12′), thus providing proper adherence/grip of the plug membrane to the spindle nut head.

Alternatively the spindle nut according to FIGS. 5 and 6 may also be introduced/set, in a forced way, into a pre-formed thermoplastic elastomer membrane, provided with adapted/corresponding grooves and ribs/protrusions, so that once the spindle nut has been forced into place, there is adequate fitting (adherence/grip) of the TPE membrane to the spindle nut head.

The invention has thus been explained in detail having reference to particular embodiments.

It should however be observed that the details of these embodiment do not involve any limitation of the scope of the invention as disclosed in the above text and as expressed in the claims here below and that many variations within the scope of these claims will be readily apparent to the skilled art person.

1. Stopcock assembly for controlling the passage of fluids, comprising a housing (2) with an inlet (3) and an outlet (4) access and a closure plug (1) in the housing, with a spindle nut (9) and a closure membrane (6) adhering thereto, controlling the passage between the inlet (3) and outlet (4), wherein said closure membrane (6) is made of thermoplastic elastomer (TPE).

2. Stopcock assembly according to claim 1, wherein the TPE is a polyester-polyether type TPE or a polyester-polyester type TPE.

3. Stopcock assembly according to that claim 1, wherein the stopcock comprises a housing cover (5) and the housing (2) with its inlet (3) and outlet (4) accesses made of synthetic/plastic material.

4. Stopcock assembly according to claim 3, wherein the housing (2) and housing cover (5) are made of a, material selected from polypropylene, polyphenylene ether and polyamide.

5. Stopcock assembly according to claim 1, wherein the spindle nut (9) of the closure plug (1) comprises means for ensuring proper adherence/grip of the TPE closure membrane to the closure plug spindle nut.

6. Stopcock assembly according to claim 5, wherein the spindle nut comprises bores (12) and/or grooves (11) into which penetrates the TPE material of the closure membrane.

7. Stopcock assembly according to claim 6, wherein the TPE material has penetrated into the bores (12) and/or grooves (11) of the spindle nut as a result of injecting molten TPE on the spindle nut in a mould for shaping the plug membrane.

8. Stopcock assembly according to claim 5, wherein the spindle nut comprises grooves (11) and/or protrusions (13) cooperating with adapted/corresponding ribs and/or grooves on the inside of the closure membrane, to allow a forced “one-way” introduction/setting of the spindle nut in the closure membrane.

9. Stopcock assembly according to claim 3 wherein the housing with its inlet and outlet accesses consists of a molded plastic piece comprising a longitudinal duct with longitudinal reinforcing ribs, and a plug cavity provided with its axis perpendicular to said longitudinal duct, with reinforcing ribs of said plug cavity extending parallel to its axis and with at least three peripheral reinforcement zones for fixing the housing cover to the housing, and the housing cover consists of a molded plastic piece comprising a cover surface with radial reinforcement ribs and/or one or more peripheral rib(s), perpendicular to the plane of said cover surface, with at least three peripheral reinforcement zones for fixing the housing cover to the housing, and a hollow protrusion, along the axis of said plug cavity, for holding said driving spindle for the closure plug, provided with radial reinforcement ribs.

10. Closure plug component (1) for a stopcock assembly for controlling the passage of fluids, between the inlet (3) and outlet (4) of said stopcock assembly, comprising a spindle nut and a closure membrane (6) adhering thereto, wherein said closure membrane (6) is made of thermoplastic elastomer (TPE).

11. Closure plug component according to claim 10, wherein the TPE is a polyester-polyether type TPE or a polyester-polyester type TPE.

12. Closure plug component according to claim 10, wherein the spindle nut of the closure plug comprises means for ensuring proper adherence/grip of the TPE closure membrane to the closure plug spindle nut.

13. Closure plug component according to claim 12, wherein the spindle nut comprises bores and/or grooves into which penetrates the TPE material of the closure membrane.

14. Closure plug component according to claim 13, wherein the TPE material has penetrated into the bores and/or grooves of the spindle nut as a result of injecting molten TPE on the spindle nut in a mould for shaping the plug membrane.

15. Closure plug component according to claim 12, wherein the spindle nut comprises grooves and/or protrusions cooperating with adapted/corresponding ribs and/or grooves on the inside of the closure membrane, to allow a forced “one-way” introduction/setting of the spindle nut in the closure membrane.
